(19) United States
(12) Patent Application Publication
(10) Pub. No.: US 2004/0026604 A1
(43) Pub. Date: Feb. 12, 2004

(54) Optical transceiver

(76) Inventors: Toru Nishikawa, Hirakata-shi (JP); Tomoaki Uno, Kobe-shi (JP)

Correspondence Address: SNELL & WILMER L.L.P, Suite 1200, 1920 Main Street, Irvine, CA, 92614-7230, US

(21) Appl. No.: 10/409,551

(22) Filed: Apr. 8, 2003

(30) Foreign Application Priority Data
Apr. 9, 2002 (JP) 2002-106179
Sep. 30, 2002 (JP) 2002-285788

(51) Int. Cl. H01J 40/14

(52) U.S. Cl. 250/214 R

(57) ABSTRACT

An optical transceiver including: a light emitting unit for emitting light having a predetermined wavelength; a light reception unit for receiving light; an optical waveguide an end surface of which is introduced into a body of the optical transceiver. The optical waveguide receives and releases light through the end surface. The optical transceiver also includes a light branching unit deposited between the light emitting unit and the end surface of the optical waveguide at a distance from each of them, and is within directional angles of the light emitted from the light emitting unit and light released from the end surface of the optical waveguide. The light branching unit allows the light emitted from the light emitting unit to enter the end surface of the optical waveguide, and the light released from the end surface of the optical waveguide to be received by the light reception unit.

### OF THE INVENTION

(1) Field of the Invention

The present invention relates to an optical transceiver that transmits and receives optical signals via a piece of optical fiber.

(2) Description of the Related Art

In recent years, a fiber-to-the-user system using the WDM (Wavelength Division Multiplexing) technology for transmitting and receiving a plurality of optical signals via a piece of optical fiber has been proposed. The WDM is a communication system in which a plurality of optical signals having different wavelengths are multiplexed and transferred simultaneously.

Optical transceivers are installed in home of users being subscribers to the fiber-to-the-user system and in the system operator's stations. The optical transceivers have (a) a function to convert electric signals into optical signals and output the optical signals and (b) a function to convert received optical signals into electric signals and input the electric signals.

Now, an optical transceiver disclosed in Japanese Laid-Open Patent Application No. 11-202140 will be described, for example.

The optical transceiver has an optical substrate, a semiconductor laser, a photodiode, and a WDM filter. An optical waveguide is formed on the optical substrate. Also, the semiconductor laser, photodiode, and WDM filter are mounted on the optical substrate.

The optical transceiver can couple optical signals emitted from the semiconductor laser with the optical waveguide with a high coupling efficiency. Also, in the optical transceiver, the semiconductor laser and the photodiode are arranged with a great distance and the WDM filter in between. This construction provides a high crosstalk characteristic. It is considered that such an optical transceiver is suitable for long-distance and broadband fiber-to-the-user systems.

However, for small- to medium-sized fiber-to-the-user systems having optical fiber communication networks for medium or short distances of no longer than 30 km and having a communication speed of up to approximately 250 Mbps, the above-described high coupling efficiency and crosstalk characteristic are considered to be overdesigned.

In the manufacturing of the above-described optical transceiver, (1) the semiconductor laser should be aligned with the optical axis of the optical waveguide, (2) the optical waveguide should be aligned with a slit of the WDM filter which is formed by a dicing saw, and (3) the optical fiber being an external transfer path should be aligned with the optical axis of the optical waveguide. The performance of the three alignments requires a high level of accuracy, thus requiring an expensive, high-precision mounting apparatus and a high production cost.

### SUMMARY OF THE INVENTION

The object of the present invention is therefore to provide an optical transceiver that is suitable for small- to medium-sized fiber-to-the-user systems that do not require high coupling efficiency and crosstalk characteristic, and can be manufactured at a low cost.

The above object is fulfilled by an optical transceiver comprising: a light emitting unit operable to emit light having a predetermined wavelength; a light reception unit operable to receive light; an optical waveguide an end surface of which is introduced into a body of the optical transceiver, the optical waveguide operable to receive and release light through the end surface; and a light branching unit which is deposited between the light emitting unit and the end surface of the optical waveguide at a distance from each thereof so as to be within (i) a directional angle of the light having the predetermined wavelength emitted from the light emitting unit and (ii) a directional angle of light released from the end surface of the optical waveguide, and operable to allow the light emitted from the light emitting unit to enter the end surface of the optical waveguide and allow the light released from the end surface of the optical waveguide to be received by the light reception unit.

With the above-described construction, the mounting tolerance of the light emitting unit is increased. This eliminates the necessity of a high-precision mounting and an expensive mounting apparatus in manufacturing the optical transceiver of the present invention. That is to say, the manufacturing cost can be reduced.

In the above optical transceiver, a light intercepting film may be formed in the light branching unit so as to prevent the light having the predetermined wavelength emitted from the light emitting unit from being received by the light reception unit.

Alternatively, the above optical transceiver may further comprise a light intercepting unit which is deposited on an optical path from the light branching unit to the light reception unit, of the light having the predetermined wavelength emitted from the light emitting unit.

With the above-described construction, it is possible to intercept the light emitted from the light emitting unit so that the light is not received by the light reception unit.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows an arrangement of optical parts constituting the optical transceiver in Embodiment 1;

FIG. 2 is a cross-sectional view of the optical transceiver taken substantially along line A-A′ of FIG. 1;

FIG. 3 is a cross-sectional view of the optical transceiver taken substantially along line C-C′ of FIG. 1;

FIG. 4 is a cross-sectional view of a photodiode having a light refracting film;

FIG. 5 is a plot of the excess loss between the semiconductor laser and the optical fiber (or optical waveguide) vs. the amount of displacement of the semiconductor laser;

FIG. 6 is a plot of the coupling efficiency between the semiconductor laser and the optical fiber (or optical waveguide) vs. the amount of displacement of the semiconductor laser;

FIG. 7 is a plot of the coupling efficiency between the semiconductor laser and the optical fiber vs. the amount of displacement of the semiconductor laser in the conventional optical transceiver;

FIG. 8 shows a part of the optical transceiver having the wavelength branch filter in which a light intercepting unit is formed;

FIG. 9A shows an example of the shape of the light intercepting unit formed in the wavelength branch filter;

FIG. 9B shows an example of the shape of the light intercepting unit formed in the wavelength branch filter;

FIG. 10 is a cross-sectional view of a photodiode having a light refracting film and a 1.3 μm-wavelength-light absorbing layer;

FIG. 11 shows a light-receiving photodiode when viewed from below;

FIG. 12 shows an arrangement of optical parts constituting the optical transceiver in Embodiment 2;

FIG. 13 shows the filter block in Embodiment 2;

FIG. 14 shows the filter block in Embodiment 2 on a surface of which a light intercepting film is formed;

FIG. 15 shows an arrangement of optical parts constituting the optical transceiver in Embodiment 3;

FIG. 16 shows an arrangement of optical parts constituting the optical transceiver in Embodiment 4;

FIG. 17 shows a metal light intercepting wall formed on the optical platform;

FIG. 18 shows a metal light intercepting wall formed on the optical platform;

FIG. 19 is a plot of the angle α formed by the optical axis of the semiconductor laser with the optical axis of the optical fiber vs. the coupling efficiency between the semiconductor laser and the optical fiber;

FIG. 20 is a plot of the distance between the optical fiber and the light-receiving photodiode vs. the coupling efficiency;

FIG. 21 shows an example of the shape of an end of the optical fiber facing the wavelength branch filter; and

FIG. 22 shows an example of the shape of an end of the optical fiber facing the wavelength branch filter.

### DESCRIPTION OF THE PREFERRED EMBODIMENT

The following describes several embodiments of an optical transceiver of the present invention, with reference to the attached drawings.

### Embodiment 1

Construction

The following describes the construction of an optical transceiver in Embodiment 1.

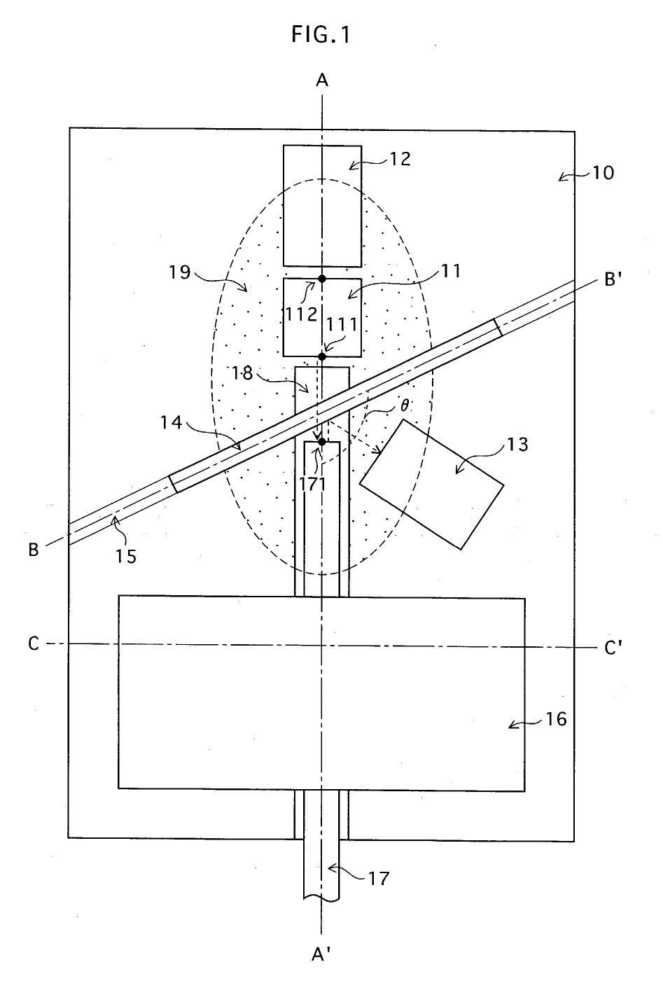

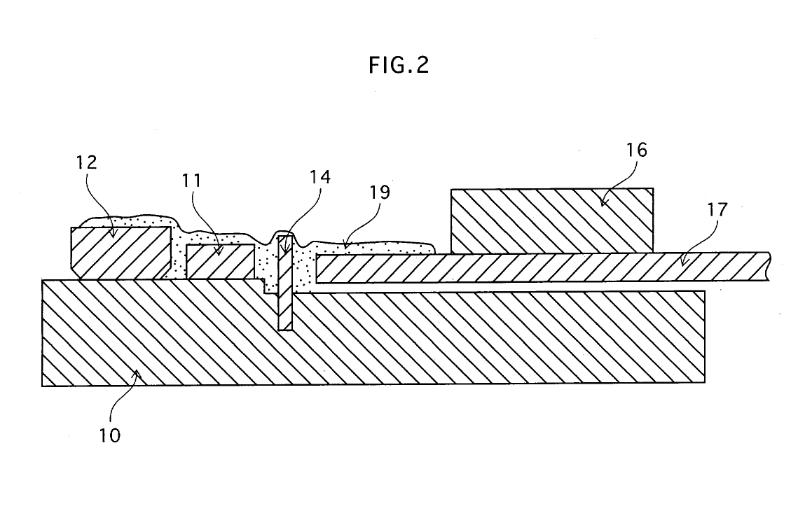

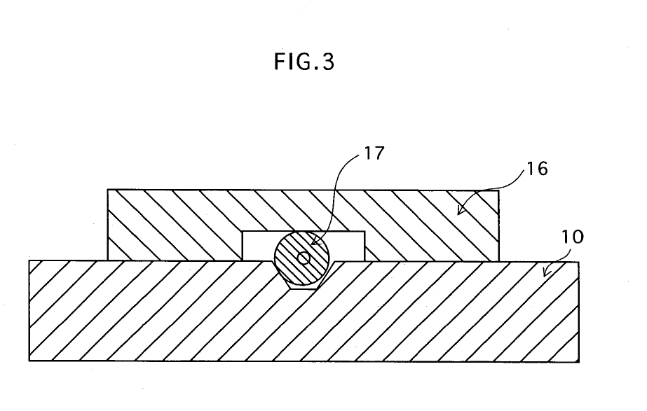

FIG. 1 shows an arrangement of optical parts constituting the optical transceiver in Embodiment 1. FIG. 2 is a cross-sectional view of the optical transceiver taken substantially along line A-A′ of FIG. 1. FIG. 3 is a cross-sectional view of the optical transceiver taken substantially along line C-C′ of FIG. 1.

The optical transceiver includes an optical platform 10, a semiconductor laser 11, a photodiode 12, a photodiode 13, a wavelength branch filter 14, a member 16, an optical fiber 17, and a resin 19. Now, each optical part will be described.

Optical Platform 10

The optical platform 10 is a silicon substrate. On a surface of the optical platform 10, slits 18 and 15, in which the optical fiber 17 and the wavelength branch filter 14 are respectively disposed, are formed. An angle θ which the central axis (axis A-A′) of the slit 18 forms with the central axis (axis B-B′) of the slit 15 is 120 degrees. The reason why the angle is set to 120 degrees will be described later.

Optical Fiber 17

The optical fiber 17 receives an optical signal at an end surface 171 where the core is exposed. The optical fiber 17 also releases an optical signal, which has been received at another end surface, from the end surface 171. As shown in FIGS. 1 to 3, the optical fiber 17 is disposed in the slit 18 formed on the surface of the optical platform 10, with the member 16 deposited thereon.

Semiconductor Laser 11

The semiconductor laser 11 has a function to emit an optical signal being a laser beam having wavelength of 1.3 μm, from light emitting points 111 and 112 in the direction of the A-A′ axis. As shown in FIG. 1, the semiconductor laser 11 is dice-bonded with the surface of the optical platform 10 so that the optical fiber 17 is approximately aligned with the optical axis. A distance “m” between the end surface 171 of the optical fiber 17 and the light emitting points 111 of the semiconductor laser 11 is at least 100 μm. The reason why the distance m is set to no smaller than 100 μm will be described later.

Photodiode 12

The photodiode 12 receives an optical signal that has a wavelength of 1.3 μm and is emitted from the semiconductor laser 11, and monitors the received optical signal. As shown in FIG. 1, the photodiode 12 is dice-bonded with the surface of the optical platform 10.

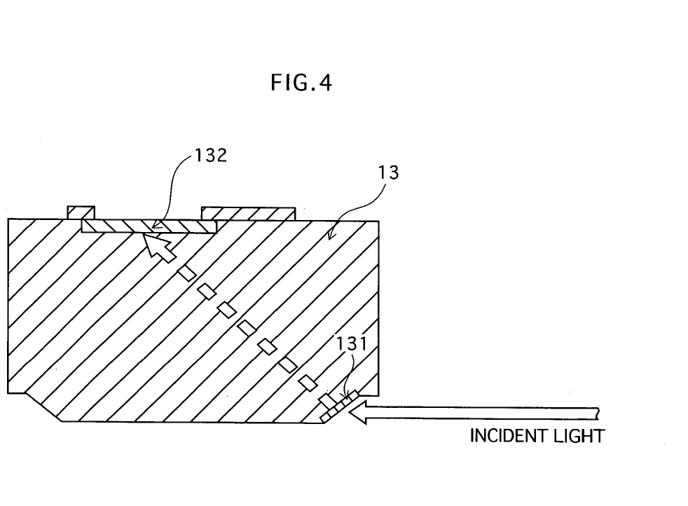

Now, the photodiode 12 in Embodiment 1 will be described with reference to FIG. 4. Though FIG. 4 is a cross-sectional view of a photodiode 13, the figure can be applied also to the photodiode 12.

An optical signal released from the light emitting point 112 of the semiconductor laser 11 is refracted on a light refracting film 131 and enters into a light reception unit 132. It is desirable that the distance between the semiconductor laser 11 and the photodiode 12 is as short as possible so that the light reception unit 132 can receive the light signal efficiently.

Photodiode 13

The photodiode 13 receives an optical signal having a wavelength of 1.55 μm released from the end surface 171 of the optical fiber 17. As shown in FIG. 1, the photodiode 13 is dice-bonded with the surface of the optical platform 10 at a position where it can efficiently receive the optical signal with the wavelength of 1.55 μm that has been reflected by the wavelength branch filter 14.

Now, the photodiode 13 in Embodiment 1 will be described with reference to FIG. 4.

An optical signal released from the end surface 171 of the optical fiber 17 is reflected by the wavelength branch filter 14, then refracted on the light refracting film 131 of the photodiode 13 and enters into the light reception unit 132. In the photodiodes of the optical transceiver in Embodiment 1, the light reception unit 132 has a light reception diameter of no smaller than 100 μm. This arrangement is done for the purpose of reducing the degradation of sensitivity caused by displacement in a direction perpendicular to the optical axis.

It is desirable that the length of an optical signal path between the end surface 171 of the optical fiber 17 and an end surface of the photodiode 13 on the optical signal incident side is as short as possible, and the photodiode 13 is disposed at a position where this condition is met. The photodiode 13 and the optical fiber 17 should be disposed so as not to interfere the optical signal path between thereof which changes with the reflection on the wavelength branch filter 14.

Wavelength Branch Filter 14

The wavelength branch filter 14 is plate-shaped, approximately 10-30 μm thick and allows optical signals having the wavelength of 1.3 μm to pass through itself, and reflects optical signals having the wavelength of 1.55 μm. The wavelength branch filter 14 is fit into the slit 15 formed on the surface of the optical platform 10.

Resin 19

The resin 19 is made of a material that has a refractive index that is consistent with the refractive index of the core of the optical fiber 17. The resin 19 prevents the optical signal from being reflected by the end surface 171 of the optical fiber 17, providing an effect of substantially reducing the distance between optical parts. As shown in FIGS. 1 and 2, the resin 19 fills spaces between optical parts, covering the optical parts The optical signals released from the light emitting point 112 of the semiconductor laser 11 and released from the end surface 171 of the optical fiber 17 radiate at certain directional angles when they pass through the resin 19.

Comparison with Conventional Apparatus

The following describes how the optical transceiver in Embodiment 1 eliminates three causes of the high production cost in manufacturing the conventional optical transceiver disclosed in Japanese Laid-Open Patent Application No. 11-202140.

Cause 1

One of the causes of the high production cost of the conventional optical transceiver is the smallness of the mounting tolerance. That the mounting tolerance is small indicates that an expensive mounting apparatus should be installed to achieve a high-precision mounting.

For the conventional optical transceiver, the semiconductor laser and the optical waveguide are directly coupled with each other, or coupled via a light-gathering means such as a lens or a diffraction means such as a diffraction grating. The major goal of either of the coupling methods is to increase the coupling efficiency. However, these coupling methods also have a negative aspect that the excess loss and the coupling efficiency greatly change depending on an amount of relative displacement between the semiconductor laser and the optical waveguide.

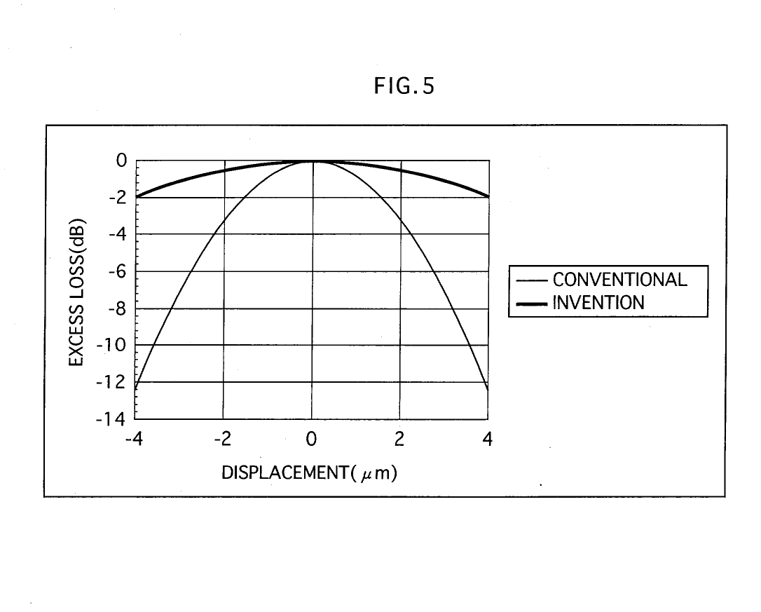

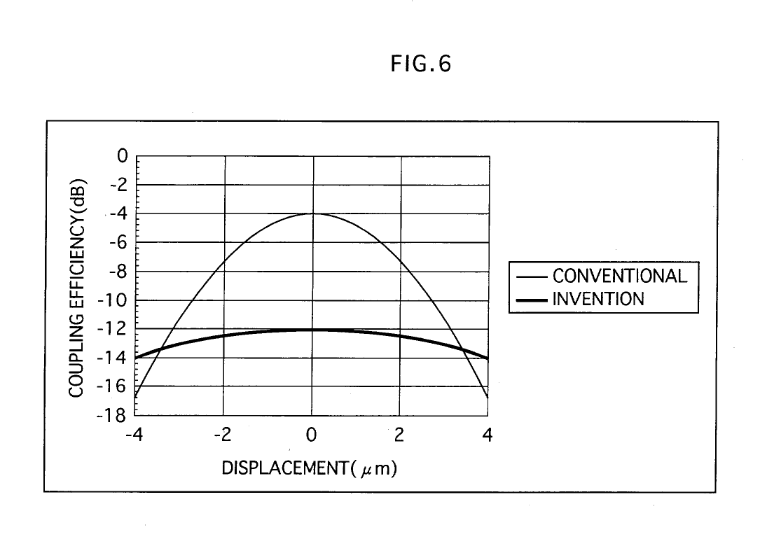

Now, (i) the relationships between the excess loss between the semiconductor laser and the optical fiber (or optical waveguide) and the amount of displacement and (ii) the relationships between the coupling efficiency between the semiconductor laser and the optical fiber (or optical waveguide) and the amount of displacement will be discussed with reference to FIGS. 5 and 6, for each of the conventional and present-invention optical transceivers.

FIG. 5 is a plot of the excess loss between the semiconductor laser and the optical fiber (or optical waveguide) vs. the amount of displacement of the semiconductor laser. FIG. 6 is a plot of the coupling efficiency between the semiconductor laser and the optical fiber (or optical waveguide) vs. the amount of displacement of the semiconductor laser.

In FIG. 5, if the mounting tolerance is regarded to be expressed by the displacement values that do not cause the excess loss between the semiconductor laser and the optical waveguide to exceed 2 dB, the mounting tolerance of the semiconductor laser in the conventional optical transceiver is ±1.6 μm. To meet this condition, a high-precision mounting apparatus is required.

On the other hand, as understood from FIG. 5, the mounting tolerance of the semiconductor laser in the optical transceiver in Embodiment 1 is ±4 μm.

FIG. 6 indicates that since the optical signal released from the light emitting point 111 radiates, if the distance between the semiconductor laser 11 and the optical fiber 17 is great enough as is the case with the optical transceiver in Embodiment 1, the amount of reduction of the coupling efficiency, which varies depending on the displacement of the semiconductor laser 11, is small.

As understood from the above description, to manufacture the optical transceiver in Embodiment 1, an expensive mounting apparatus is not necessary since a high mounting precision is not required.

Also, for a medium-sized fiber-to-the-user system having an optical fiber communication network for approximately 30 km of medium distance in which only approximately 0.1-0.2 W of optical output is required, if the distance m is great and the coupling efficiency is low as is the case with the optical transceiver in Embodiment 1, it hardly affects the transmission or reception of optical signals.

Cause 2

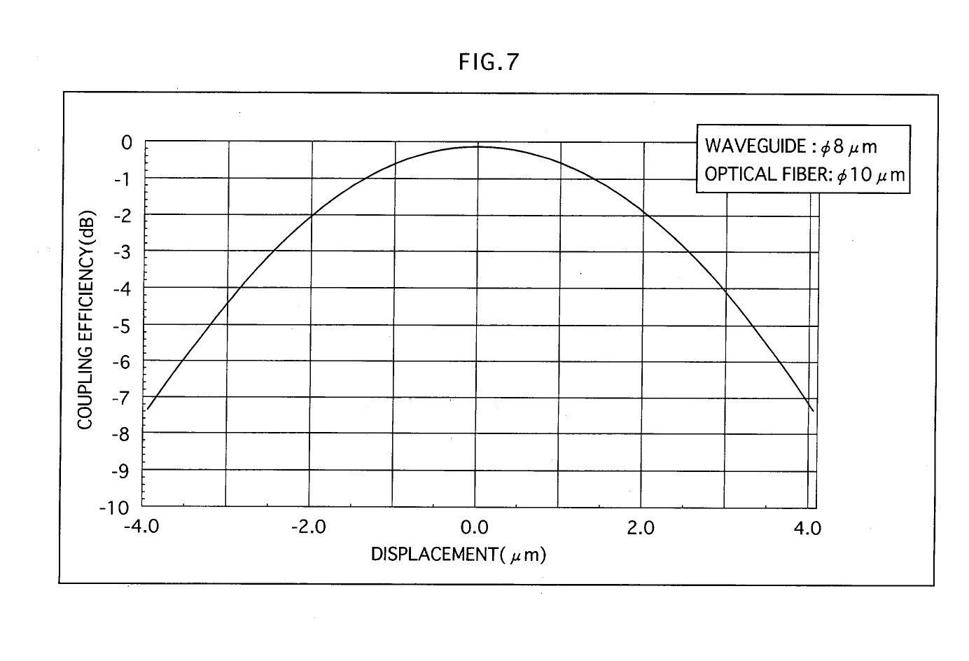

Now, the mounting tolerance of the optical fiber for a case where it is coupled with the optical waveguide in the conventional optical transceiver will be described with reference to FIG. 7. FIG. 7 is a plot of the coupling efficiency between the semiconductor laser and the optical fiber vs. the amount of displacement of the semiconductor laser in the conventional optical transceiver.

As shown in FIG. 7, for the conventional optical transceiver to obtain the coupling efficiency with the optical fiber of no lower than −2 dB, the mounting tolerance of ±2 μm is necessary. Since it is difficult for the passive alignment method to meet this condition, the active alignment method has been used. However, the active alignment method generates much expense in time and effort, and increases the mounting cost as much.

On the other hand, in the optical transceiver in Embodiment 1, the optical fiber 17 also serves as the optical waveguide, and there is no need to adjust the optical coupling between the optical waveguide and the optical fiber.

Cause 3

Now, the precision of the slit in which the wavelength branch filter is fitted in the conventional optical transceiver will be discussed.

According to the optical path design for the conventional optical transceiver, the optical signal emitted from the semiconductor laser is reflected by the WDM filter and enters the optical fiber being an external transfer path. However, when such an optical path design including a reflection system is adopted, the optical signal maybe partially lost on the optical path due to the displacement of the WDM filter in the position or the angle. For this reason, it was necessary to install an expensive dicing apparatus that can form a slit with high precision.

On the other hand, the optical path for the optical transceiver in Embodiment 1 is designed so that the optical signal emitted from the semiconductor laser 11 passes through the wavelength branch filter 14. As a result, in the optical transceiver in Embodiment 1, the displacement of the wavelength branch filter 14 in the position or the angle hardly affects the optical coupling at the end surface 171 of the optical fiber 17. Also, the wavelength branch filter 14 is approximately 10 μm to 30 μm thick. That is, it is thin enough. As a result, when the optical signal emitted from the semiconductor laser 11 passes through the wavelength branch filter 14, only a small amount of the optical signal is lost.

The mounting precision of the wavelength branch filter 14 is determined by the machining precision of the slit 15. When an ordinary dicing apparatus is used, the slit can be formed with the precision of approximately ±10 μm. This level of the slit formation precision is enough for the optical transceiver of the present invention, which uses a photodiode having light reception diameter of no smaller than 100 μm, to suppress the light reception sensitivity.

The mounting tolerance of the photodiode 13 varies depending on the mounting conditions or shape or the like of the photodiode, but compared with the mounting tolerance of the semiconductor laser 11, it is less exacting and does not become a large problem in mounting.

Modification

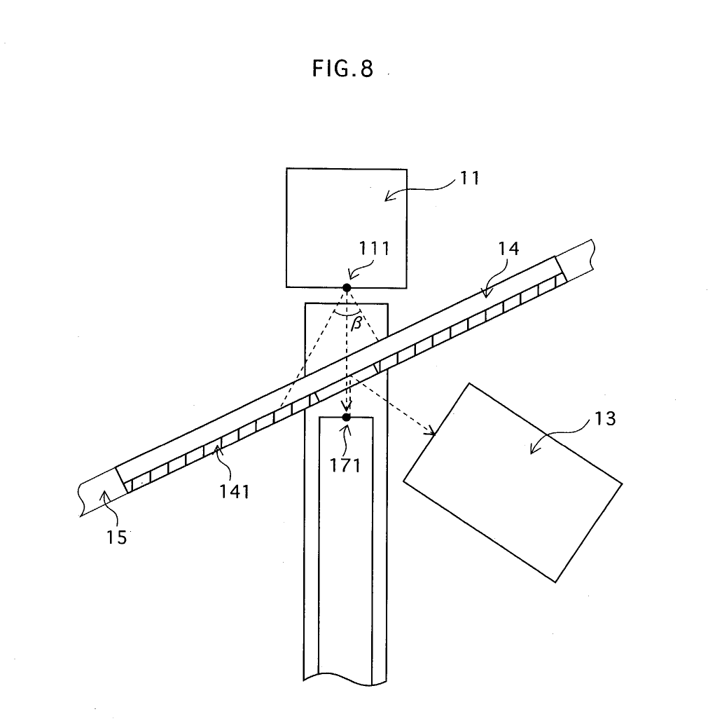

Now, a modification of Embodiment 1, in which the wavelength branch filter 14 has a light intercepting unit, will be described. FIG. 8 shows a part of the optical transceiver where a light intercepting unit 141 is formed in the wavelength branch filter 14.

The light intercepting unit 141 is aimed to prevent the photodiode 13 from receiving the optical signal that has been emitted from the semiconductor laser 11 and has radiated at a directional angle β. The light intercepting unit 141 may be a vapor-deposition metal film which can be formed on a filter surface of the wavelength branch filter 14 with ease. Alternatively, the light intercepting unit 141 may be a wavelength selection film that has a high reflectivity for the wavelength of the semiconductor laser.

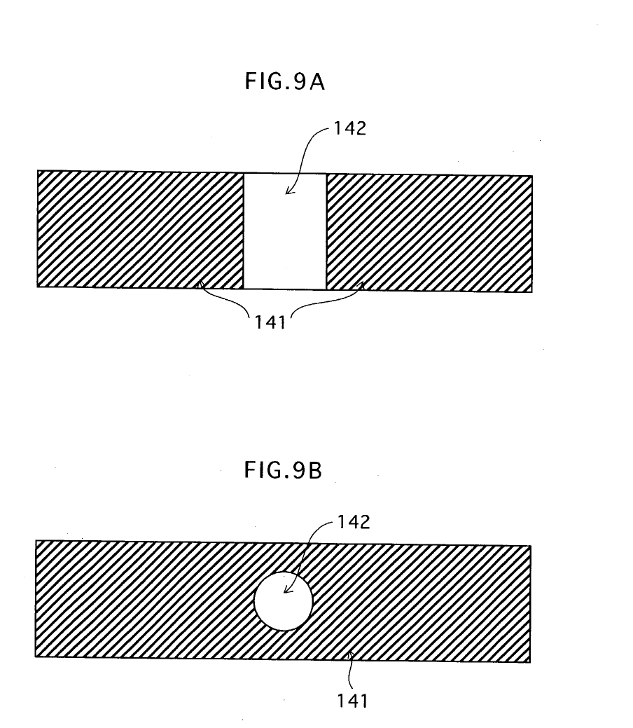

As shown in FIGS. 9A and 9B, the light intercepting unit 141 is not formed on the entire filter surface of the wavelength branch filter 14, but has a window 142 therein. The window 142 should be large enough not to interfere the coupling between the semiconductor laser 11 and the optical fiber 17. Considering the filter mounting precision, it is desirable that the window 142 has a diameter or width of approximately 50 μm to 150 μm, with the optical axis being the center of the diameter or width.

Supplement

(1) The photodiode for receiving a wavelength of 1.3 μm may have a light reception unit of a pass-band structure that has no sensitivity for the light having a wavelength of 1.55 μm.

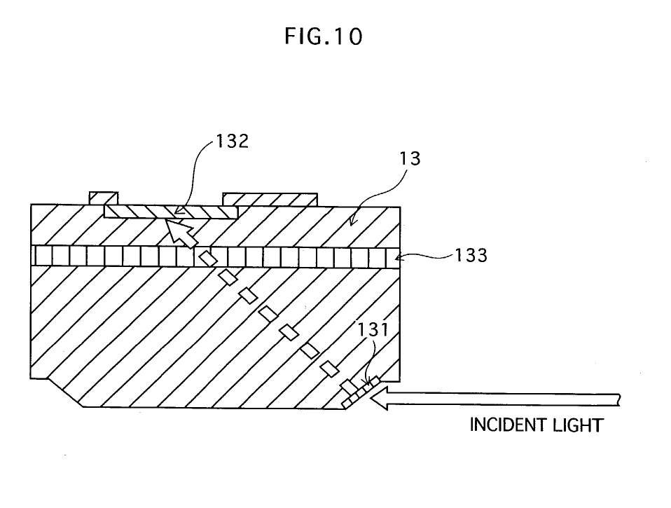

(2) FIG. 10 is a cross-sectional view of a photodiode for receiving a wavelength of 1.55 μm which may be used in the optical transceiver of the present invention. As shown in FIG. 10, the photodiode has a 1.3 μm-wavelength-light absorbing layer 133 below the light reception unit 132, where the 1.3 μm-wavelength-light absorbing layer 133 passes through the light having the wavelength of 1.55 μm and absorbs the light having the wavelength of 1.3 μm. Alternatively, the photodiode may be a photodiode chip on a surface of which a metal light intercepting pattern is formed.

(3) To prevent the light reception sensitivity from degrading due to reflections, a no-reflection coating may be applied to the light refracting film 131 of the photodiode for receiving the light.

(4) A material having a refractive index close to the refractive index of the optical fiber may be used as a material of a substrate of the wavelength branch filter 14 so as to prevent excess reflection.

(5) The semiconductor laser 11 is not limited to the general Fabry-Perot structure, but may be a DFB laser.

(6) The structure of the optical waveguide of the semiconductor laser 11 is not limited to the ordinary parallel stripe structure, but may be the taper stripe structure that can change the light spot size.

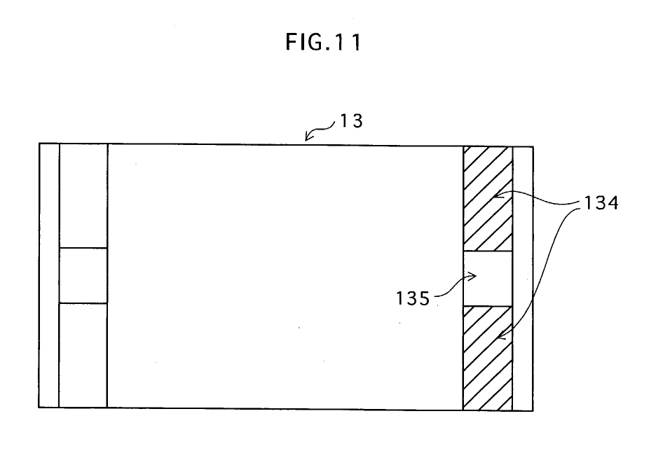

(7) FIG. 11 shows a light-receiving photodiode when viewed from below. As shown in FIG. 11, a light intercepting metal 134, which is made of the same material as the material of the back-surface electrodes may be attached to the incident surface of the light-receiving photodiode, by the vapor deposition.

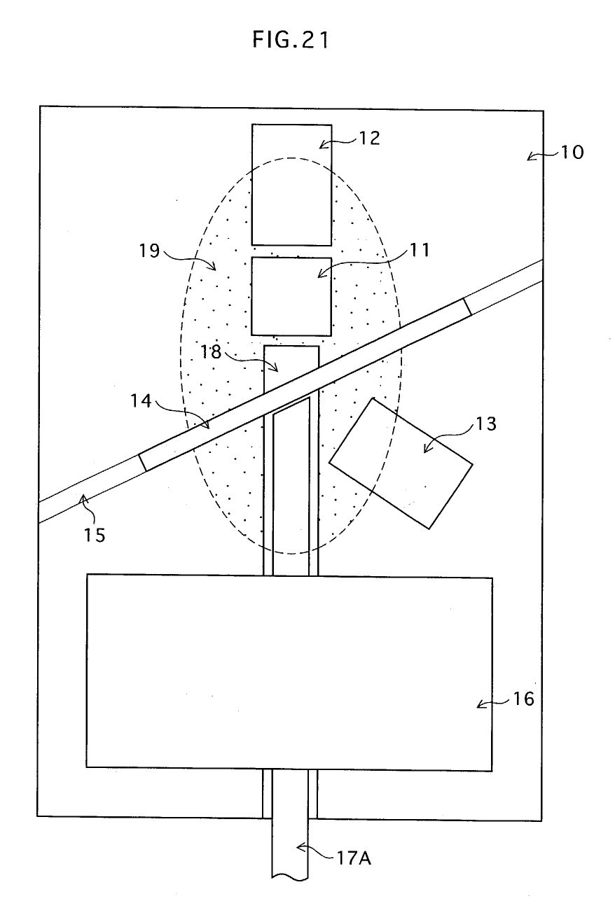

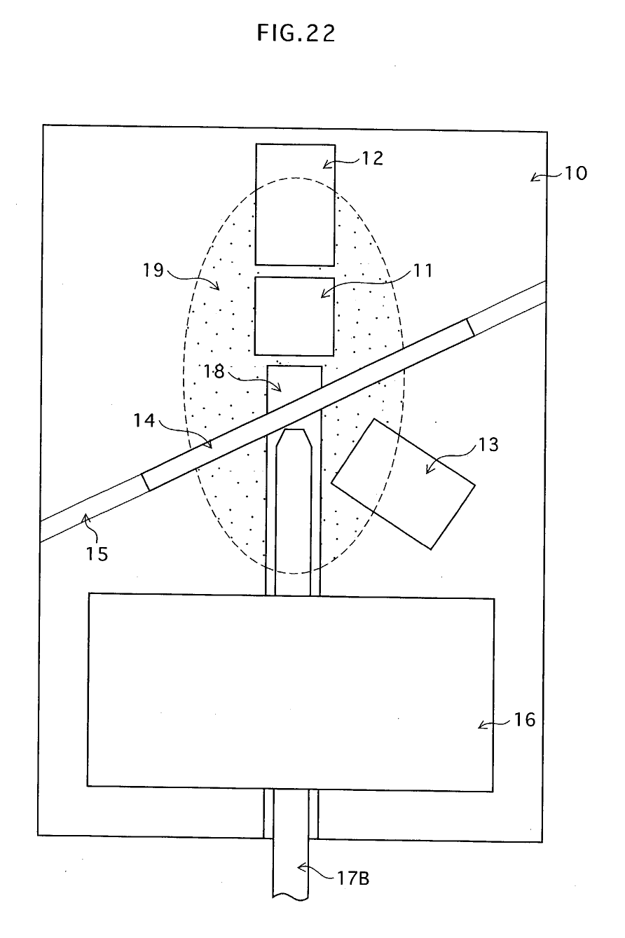

(8) To enhance the coupling efficiency of the optical signal between the semiconductor laser 11 and the optical fiber 17, an optical fiber 17A or an optical fiber 17B may be used, where an end of the optical fiber 17A is cut at a bevel as shown in FIG. 21, and an end of the optical fiber 17B is chamfered into a conical shape as shown in FIG. 22.

(9) If the semiconductor laser 11 is set to emit the optical signal having the wavelength of 1.55 μm, the photodiode 13 is set to receive the optical signal having the wavelength of 1.3 μm.

(10) It has been difficult to downsize an optical transceiver that uses a conventional optical waveguide because downsizing of the substrate of the optical waveguide is difficult. However, in the optical transceiver in Embodiment 1, since an optical fiber 17 installed in the optical transceiver itself is also used as an optical waveguide, the slit in which the optical fiber is fitted can be formed by the known technologies of lithography and etching. This enables the optical platform 10 to be downsized. A silicon substrate is used for the optical platform 10. As a result, a V-shaped slit can be formed with great precision by wet etching.

### Embodiment 2

The following describes an optical transceiver in Embodiment 2 with reference to the attached drawings.

Since the optical transceiver in Embodiment 2 have many characteristics in common with the optical transceiver in Embodiment 1, only characteristics unique to Embodiment 2 will be explained in the following description. The difference is that a filter block is used as the wavelength branch filter.

Construction

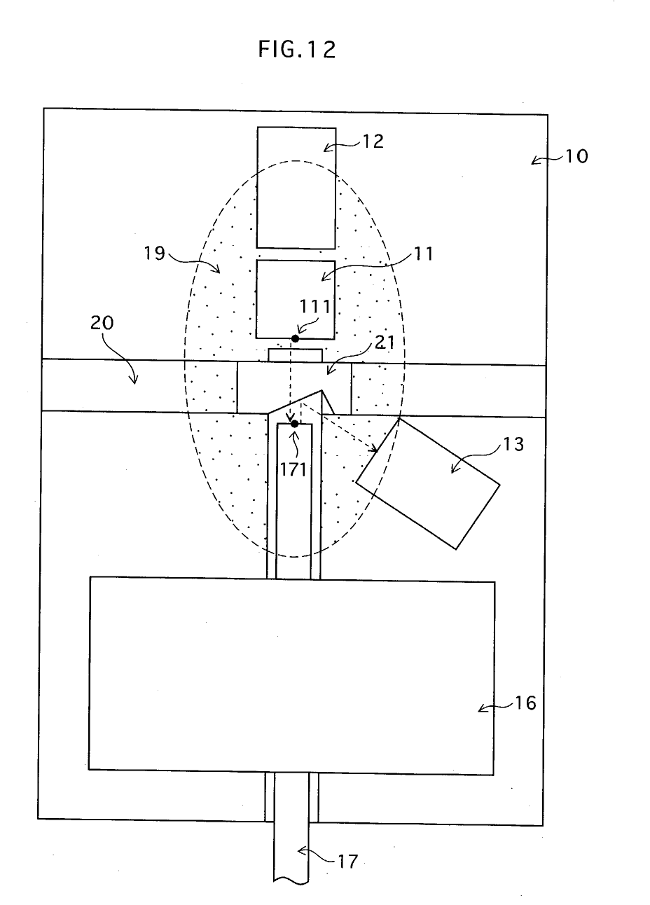

FIG. 12 shows an arrangement of optical parts constituting the optical transceiver in Embodiment 2.

In the optical platform 10 in Embodiment 2, a slit 20 is formed instead of the slit 10 in Embodiment 1. Also, a filter block 21 is fitted into the slit 20.

The filter block 21 is made of glass, and is no smaller than 100 μm thick. As shown in FIG. 12, the filter block 21 is deposited between the semiconductor laser 11 and the optical fiber 17, and has an oblique surface which forms an angle of approximately 120 degrees with the optical axis of the optical fiber 17.

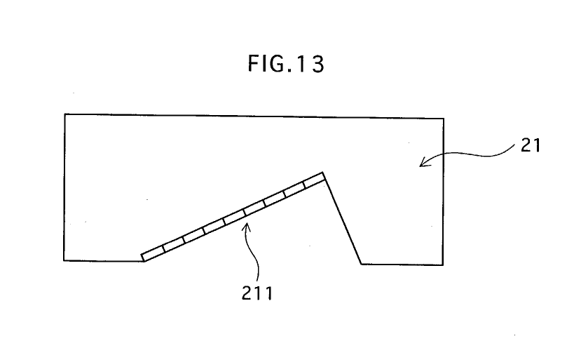

FIG. 13 shows the filter block 21 formed in the optical platform 10. A wavelength branch filter 211 is formed on the oblique surface which forms an angle of approximately 120 degrees with the optical axis of the optical fiber 17. The wavelength branch filter 211 is a multi-layered dielectric film.

In Embodiment 1, a very thin, 10-to-30 μm-thick wavelength branch filter is used. In the case of such a wavelength branch filter, it is difficult to discern between the front and back surfaces, and there is a fear that the automatic mounting efficiency is decreased due to warpage, which is apt to happen because of its thinness. In contrast, as is the case with Embodiment 2, when the filter block 21 being no smaller than 100 μm thick is used, an image recognition during aligning of the optical path is easier and the damage is less apt to be caused during a handling operation than in the case where the thin wavelength branch filter 14 is used. This prevents reduction in mounting yields.

Supplement

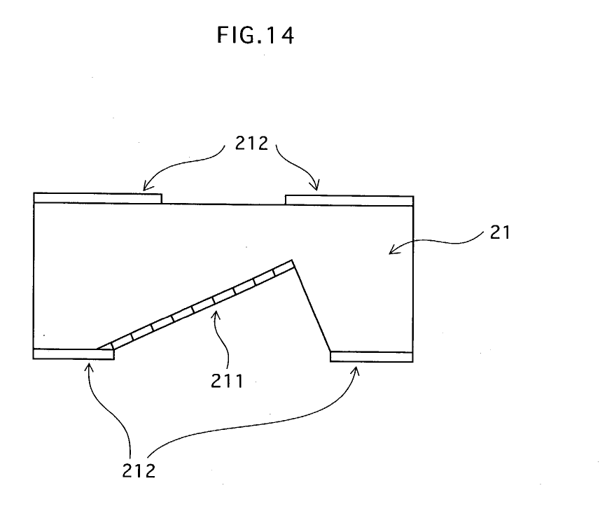

(1) As shown in FIG. 14, a light intercepting film 212 may be formed on certain portions of a surface of the filter block 21. The light intercepting film 212 may be a vapor-deposition metal film which can be formed with ease and provide an effective light intercepting property. Alternatively, the light intercepting film 212 may be a wavelength selection film that has a high reflectivity for the wavelength of the optical signal emitted from the semiconductor laser 11.

(2) The mounting precision of the filter block 21 is not affected by the machining precision of the slit 20, but depends on only the mounting precision of the filter block 21. When an ordinary manufacturing tool is used, the mounting precision is approximately ±10 μm, and the sensitivity degradation is approximately 5%.

(3) When it is intended to obtain a high coupling efficiency by reducing the distance between the semiconductor laser 11 and the optical fiber 17, the thickness of the filter block 21 can be reduced for this purpose.

(4) It is desirable that the filter block 21 is made of a material that have a refractive index that is close to a refractive index of the core of the optical fiber 17. When glass is used as the material of the filter block 21, the oblique surface can be formed by the glass press working. Also, when plastic is used as the material of the filter block 21, the oblique surface can be formed by the metal mold working with ease. Also, when silicon is used as the material of the filter block 21, the oblique surface can be formed by the selective etching using an off substrate. It should be noted here that when silicon is used as the material of the filter block 21, a no-reflection coating should be applied onto the side of the filter block 21 opposite the oblique surface side. Also, since the refractive index of silicon is different from that of the core of the optical fiber 17, the design of the optical system should be changed by considering the difference between the refractive indexes.

(5) In FIG. 13, the wavelength branch filter 211 of the filter block 21 is formed on the side of the optical fiber 17. However, the wavelength branch filter 211 may be formed on the side of the semiconductor laser 11.

### Embodiment 3

The following describes an optical transceiver in Embodiment 3 with reference to the attached drawings. Since the optical transceiver in Embodiment 3 have many characteristics in common with the optical transceiver in Embodiment 1, only characteristics unique to Embodiment 3 will be explained in the following description. The difference is that the optical transceiver in Embodiment 3 has an intercepting filter that prevents the optical signal emitted from the semiconductor laser from entering into the light-receiving photodiode.

Construction

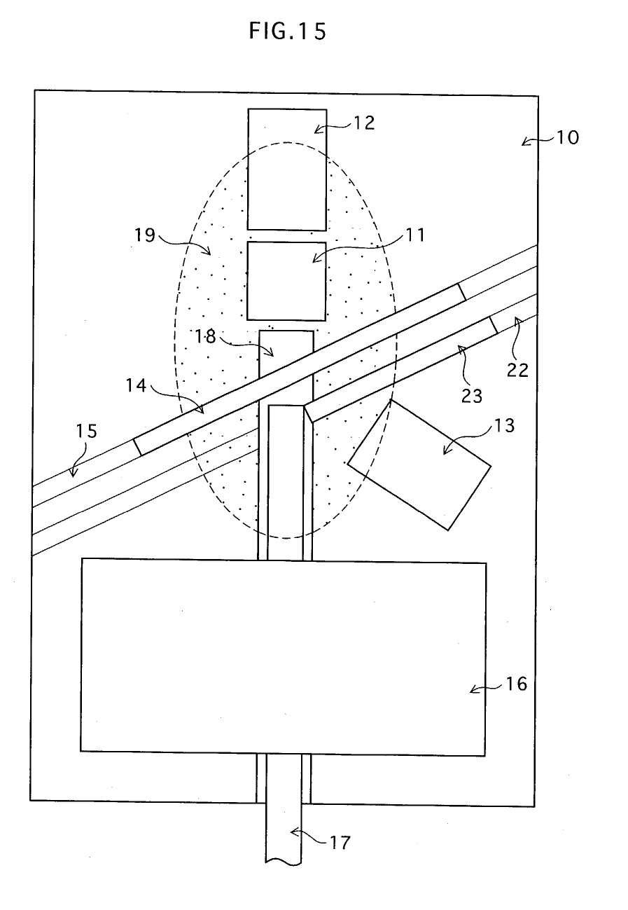

FIG. 15 shows an arrangement of optical parts constituting the optical transceiver in Embodiment 3.

In the optical platform 10 in Embodiment 3, a slit 22 is formed in parallel to the slit 15, as well as the slits 15 and 18 described in Embodiment 1. An intercepting filter 23 is fitted into the slit 22. The slit 22 is deep enough for the intercepting filter 23 to intercept the optical signal that travels radiating after emitted from the semiconductor laser 11.

A wavelength selection film, which has a high reflectivity for the wavelength of the optical signal emitted from the semiconductor laser 11, is formed on a filter surface of the intercepting filter 23.

The above-described construction prevents the optical signal emitted from the semiconductor laser 11 from entering into the photodiode 13.

In FIG. 15, the intercepting filter 23 sticks in the optical fiber 17. However, the intercepting filter 23 may be arranged so as to be in the vicinities of an end surface of the optical fiber 17 in so far as the intercepting filter 23 does not interfere the coupling of the semiconductor laser 11 with the optical fiber.

### Embodiment 4

The following describes an optical transceiver in Embodiment 4 with reference to the attached drawings. Since the optical transceiver in Embodiment 4 have many characteristics in common with the optical transceiver in Embodiment 1, only characteristics unique to Embodiment 4 will be explained in the following description. The difference is that the optical axis of the semiconductor laser is slanted from the optical axis of the optical fiber to form a certain angle, with the light emitting point of the semiconductor laser being the vertex, and that a metal light intercepting wall is provided to prevent the optical signal emitted from the semiconductor laser from entering into the light-receiving photodiode.

Construction

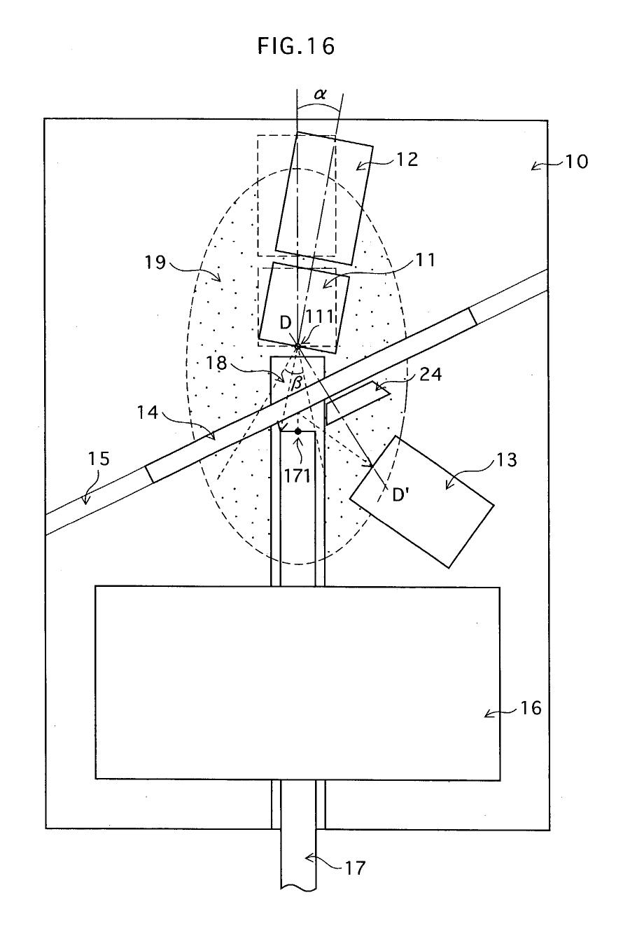

FIG. 16 shows an arrangement of optical parts constituting the optical transceiver in Embodiment 4.

As shown in FIG. 16, the semiconductor laser 11 and the photodiode 12 are arranged so that the optical axis of the optical fiber 17 forms an angle α with the optical axis of the semiconductor laser 11, with the light emitting point 111 being the vertex. The arrangement is made to reduce the amount of the optical signal entering into the photodiode 13, out of the optical signal emitted from the semiconductor laser 11.

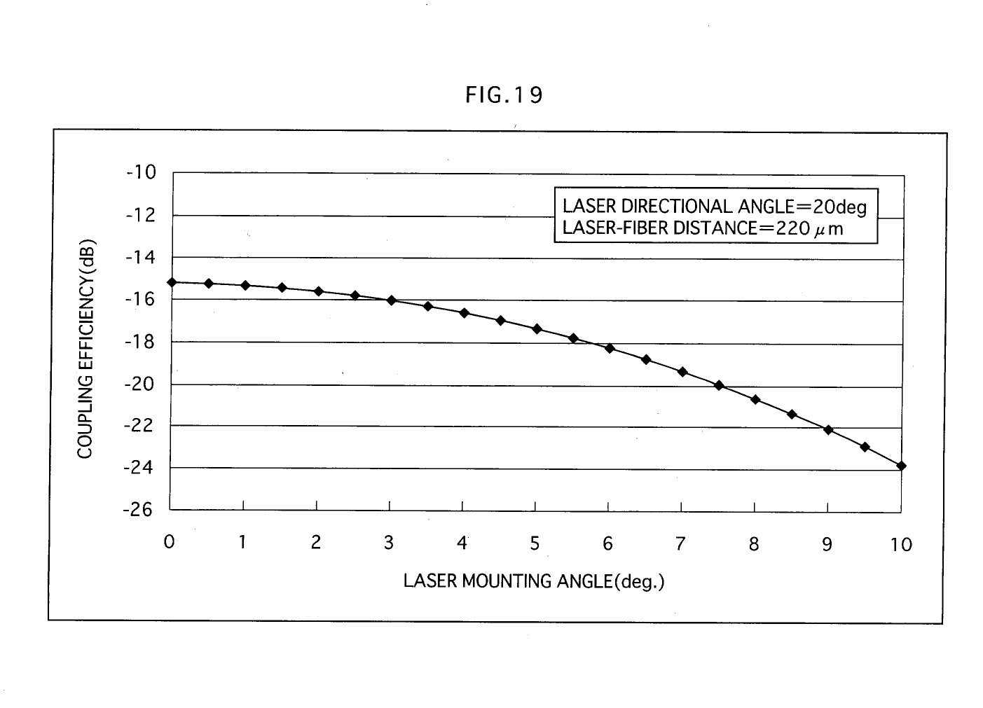

FIG. 19 is a plot of the angle α vs. the coupling efficiency between the semiconductor laser 11 and the optical fiber 17. As shown in FIG. 19, when the angle α is in a range from 3 to 5 degrees, the loss of the coupling efficiency is approximately 1 to 2 dB. This level of coupling efficiency loss is not regarded as a big problem.

A metal light intercepting wall 24 is formed by performing the metal plating on a metal on the optical platform 10. Here, the height of the metal light intercepting wall 24 will be discussed.

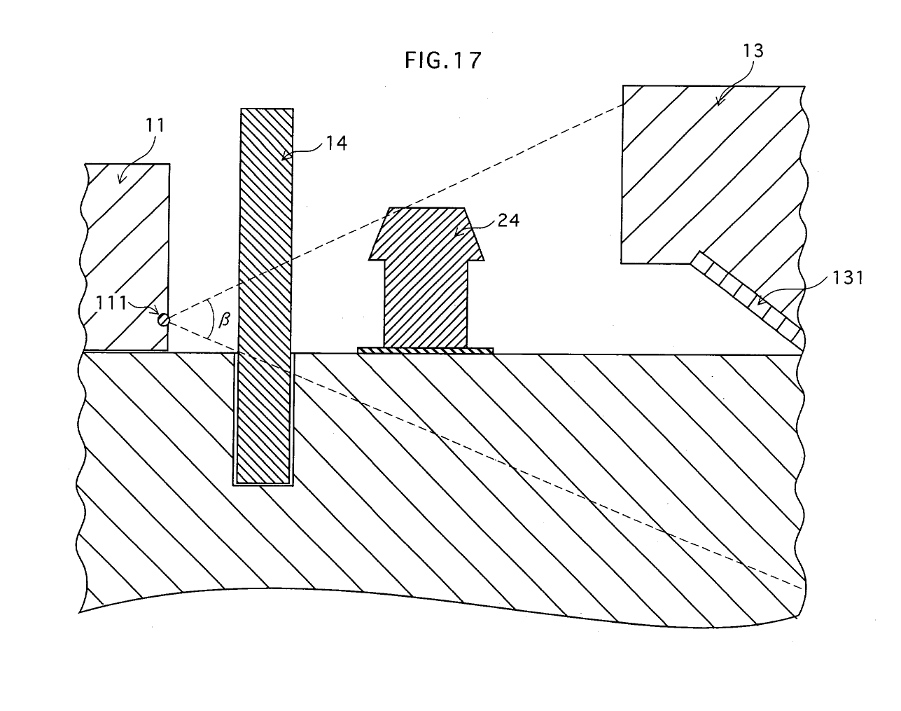

FIG. 17 is a cross-sectional view of the optical transceiver taken substantially along line D-D′ of FIG. 16. As shown in FIG. 17, the optical signal emitted from the semiconductor laser 11 travels radiating at a certain directional angle. The directional angle needs to be taken into consideration when the height of the metal light intercepting wall 24 is determined. Basically, the metal light intercepting wall 24 should be higher than the light refracting film 131 of the photodiode 13. For example, if the directional angle of the semiconductor laser 11 is 20 degrees, the metal light intercepting wall 24 is required to be 30 to 40 μm in height.

With the above-described construction, it is possible to prevent the optical signal emitted from the semiconductor laser 11 from entering into the photodiode 13.

Supplement

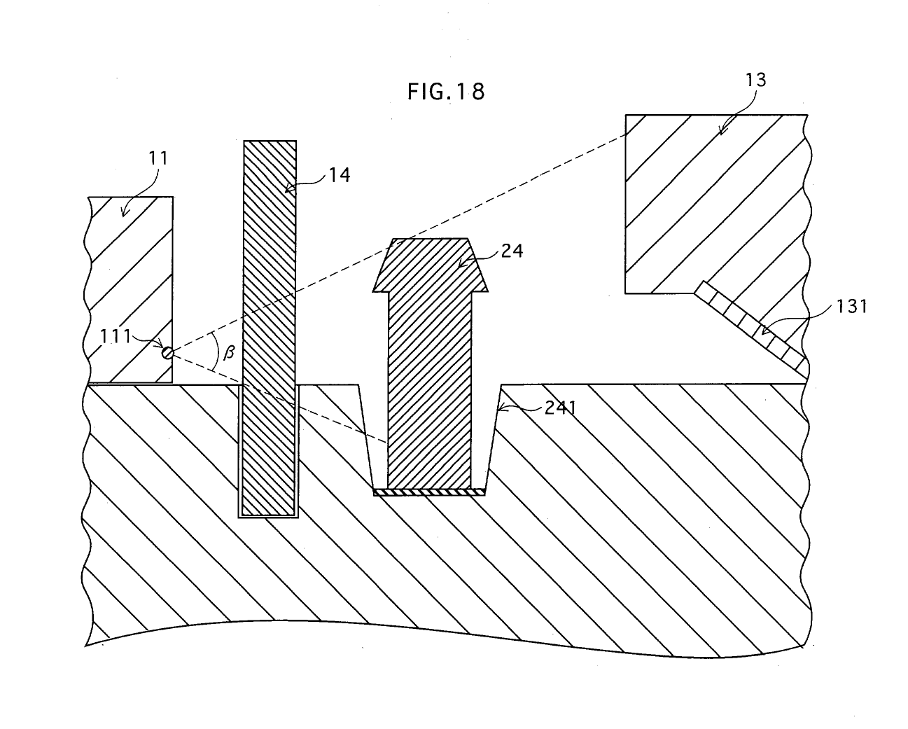

(1) To prevent the optical signal reflected by the dicing surface of the slit 15 from entering into the photodiode 13, a slit 241 as shown in FIG. 18 may be formed in the optical platform 10.

(2) To achieve a high intercepting property, the metal light intercepting wall 24 may be deposited at a position close to the slit 18 so that the photodiode 13 is hidden when viewed from the light emitting point 111.

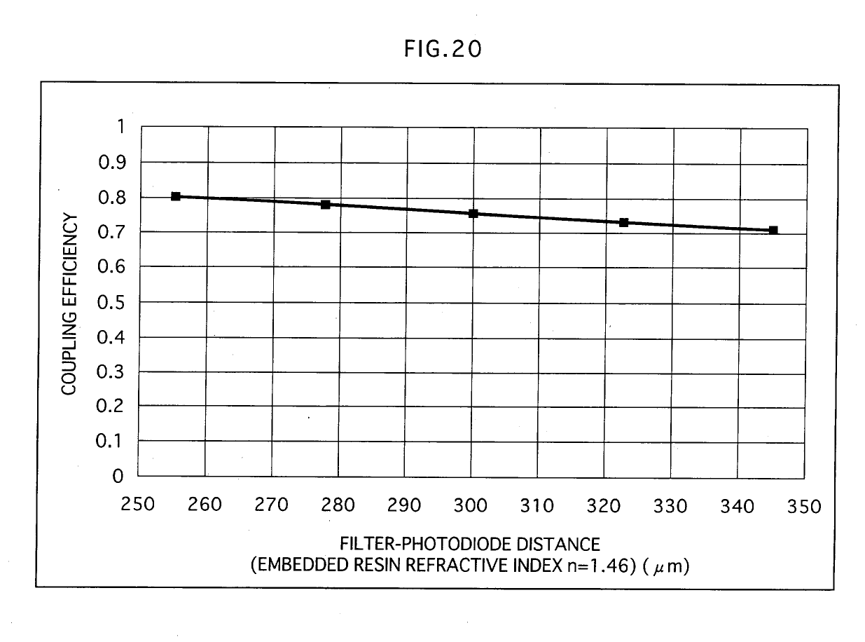

(3) It is possible to increase the light intercepting property by depositing the photodiode 13 at a position out of the range of the directional angle of the semiconductor laser 11. Meanwhile, as understood from FIG. 20, the coupling efficiency decreases as distance between the photodiode 13 and the wavelength branch filter 14 increases. As a result, the location of the photodiode 13 may be determined in accordance with a desired coupling efficiency value.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An optical transceiver comprising:
a light emitting unit operable to emit light having a predetermined wavelength;
a light reception unit operable to receive light;
an optical waveguide an end surface of which is introduced into a body of the optical transceiver, the optical waveguide operable to receive and release light through the end surface; and
a light branching unit which is deposited between the light emitting unit and the end surface of the optical waveguide at a distance from each thereof so as to be within (i) a directional angle of the light having the predetermined wavelength emitted from the light emitting unit and (ii) a directional angle of light released from the end surface of the optical waveguide, and operable to allow the light emitted from the light emitting unit to enter the end surface of the optical waveguide and allow the light released from the end surface of the optical waveguide to be received by the light reception unit.

2. The optical transceiver of claim 1, wherein a shortest optical path of the light having the predetermined wavelength from the light emitting unit to the end surface of the light waveguide is no shorter than 100 μm.

3. The optical transceiver of claim 2, wherein the light branching unit allows the light having the predetermined wavelength emitted from the light emitting unit to pass through itself and reflects light having a wavelength other than the predetermined wavelength.

4. The optical transceiver of claim 3, wherein the light branching unit is a filter including an optically transparent, plate-shaped optical substrate and a multi-layered dielectric film formed on the optical substrate.

5. The optical transceiver of claim 4, wherein the light branching unit is 10 μm to 30 μm inclusive, in thickness.

6. The optical transceiver of claim 4, wherein the optical substrate has a depression having an oblique surface, and the multi-layered dielectric film is formed on the oblique surface.

7. The optical transceiver of claim 5, wherein the shortest optical path of the light is filled with an optically transparent resin having a refractive index that is substantially equivalent to a refractive index of the optical waveguide.

8. The optical transceiver of claim 7, wherein the light emitting unit, the light branching unit, the optical waveguide, and the light reception unit are deposited on a same surface of an optical platform.

9. The optical transceiver of claim 8, wherein the light reception unit is a photodiode that receives light through an end surface thereof.

10. The optical transceiver of claim 9, wherein the light reception unit further has a light refracting film.

11. The optical transceiver of claim 10, wherein a no-reflection coating is applied to the light refracting film so that the light refracting film does not reflect the light released from the end surface of the optical waveguide.

12. The optical transceiver of claim 1, wherein the predetermined wavelength of the light emitted from the light emitting unit is 1.3 μm, and a wavelength of the light released from the end surface of the optical waveguide is 1.55 μm.

13. The optical transceiver of claim 1, wherein the predetermined wavelength of the light emitted from the light emitting unit is 1.55 μm, and a wavelength of the light released from the end surface of the optical waveguide is 1.3 μm.

14. The optical transceiver of claim 1, wherein a light intercepting film is formed in the light branching unit so as to prevent the light having the predetermined wavelength emitted from the light emitting unit from being received by the light reception unit.

15. The optical transceiver of claim 14, wherein the light intercepting film is formed on any portion other than a predetermined portion of the light branching unit, the predetermined portion including the optical path of the light having the predetermined wavelength from the light emitting unit to the end surface of the light waveguide.

16. The optical transceiver of claim 15, wherein the light intercepting film is a vapor-deposition metal film.

17. The optical transceiver of claim 1 further comprising
a light intercepting unit which is deposited on an optical path from the light branching unit to the light reception unit, of the light having the predetermined wavelength emitted from the light emitting unit.

18. The optical transceiver of claim 17, wherein the light intercepting unit is a filter that reflects the light having the predetermined wavelength and allows light having a wavelength other than the predetermined wavelength to pass through itself.

19. The optical transceiver of claim 18, wherein the light emitting unit, the light branching unit, the optical waveguide, the light reception unit, and the light intercepting unit are deposited on a same surface of an optical platform, and
a dicing slit in which the light intercepting unit is fitted is formed on the optical platform, the dicing slit having a depth that is determined by taking into account a directional angle of the light having the predetermined wavelength emitted from the light emitting unit.

20. The optical transceiver of claim 17, wherein the light intercepting unit is a metal bump.

21. The optical transceiver of claim 20, wherein the light reception unit has an incident surface that receives light, and the metal bump is higher than a position of the incident surface.

22. The optical transceiver of claim 17, wherein the light intercepting unit is formed by a metal plating.

23. The optical transceiver of claim 1, wherein the light reception unit has an incident surface that receives light, and a wavelength selection film is formed on the incident surface, the wavelength selection film reflecting the light having the predetermined wavelength emitted from the light emitting unit, and allowing the light released from the end surface of the optical waveguide to pass through itself.

24. The optical transceiver of claim 1, wherein the light reception unit has an incident surface that receives light, and a light intercepting film is formed on the incident surface excluding a predetermined portion of the incident surface.

25. The optical transceiver of claim 1, wherein the light reception unit is deposited at a position without the directional angle of the light having the predetermined wavelength emitted from the light emitting unit.

26. The optical transceiver of claim 25, wherein the light emitting unit and the optical waveguide are arranged so that an optical axis of the light emitted from the light emitting unit forms a predetermined angle with an optical axis of the light released from the optical waveguide.

27. The optical transceiver of claim 26, wherein the predetermined angle ranges from 3 degrees to 5 degrees inclusive.

28. The optical transceiver of claim 1, wherein the optical waveguide is an optical fiber and the end surface thereof is cut diagonally.

29. The optical transceiver of claim 1, wherein the optical waveguide is an optical fiber and the end surface thereof is worked so as to be substantially in parallel with an incident surface of the light branching unit.

30. The optical transceiver of claim 1, wherein the optical waveguide is an optical fiber and the end surface thereof is chamfered into a conical shape.
